(19) United States
(12) Patent Application Publication
(10) Pub. No.: US 2018/0354714 A1
(43) Pub. Date: Dec. 13, 2018

(54) PERMEABLE DISPOSABLE FILTER AND BEVERAGE SYSTEM

(71) Applicant: Shawn Alpheus Jackson, Chevy Chase, MD (US)

(72) Inventor: Shawn Alpheus Jackson, Chevy Chase, MD (US)

(21) Appl. No.: 16/105,815

(22) Filed: Aug. 20, 2018

Related U.S. Application Data
(63) Continuation of application No. 14/260,163, filed on Apr. 23, 2014, now abandoned.

(51) Int. Cl. B65D 85/804

(52) U.S. Cl. CPC B65D 85/8046; Y02W 30/807

(57) ABSTRACT

A disposable filter can replace a reusable filter in a reusable coffee filter. The disposable filter can be removed immediately after use and discarded without mess, making the single cup brewer available without delay for the next brew cycle. The disposable filter includes a basket portion having a collar, where the basket portion can fit into a reusable coffee filter holder and the collar can rest over a lip of the reusable coffee filter holder.

### BACKGROUND OF THE INVENTION

The present invention relates to single cup beverage preparation accessories and, more particularly, to a disposable beverage filter compatible with, for example, the Keurig® My K-Cup® reusable coffee filter.

Beverages are often brewed as a single cup at a time with various single cup brewers, such as the Keurig® Single Cup Coffee Brewing System or the like. These single cup brewers can be used for brewing pre-packaged, preselected products such as coffee, tea and like product medium within non-biodegradable, non-compostable, and environmentally unfriendly sealed plastic cartridges. Such a brewer uses a penetrator or needle to inject pressurized heated water into a cartridge for combination with the extract to produce a beverage.

Alternatively, these single cup brewers offer an environmentally friendly, reusable filter. This filter is typically a three-part product that includes a mini filter basket that fits into a filter holder with a cap that can be used with the user's own coffee. Such reusable filter baskets are filled with a selected coffee and positioned in a filter holder which, in turn, is positioned in the brewing chamber of a single cup brewer. The brewer's penetrator or needle enters the holder via an opening in the holder cap and injects pressurized heated water into the holder to combine with the coffee within the reusable filter basket. The outflow of the coffee beverage exits the holder via a hole, spout, exit, or the like, in its bottom and dispenses into a separate and existing cup or container.

These reusable filters, however, are prone to clogging (as identified by Boul, U.S. Pat. No. 8,221,813 B2), and can result in a slow and messy process, thereby defeating the expediency and convenience of using a single cup brewer. Additionally, like the pre-packaged cartridge, they are limited to only one chamber for the placement of product.

A prior art reusable coffee filter can hold a reusable coffee filter and a coffee filter holder cap can fit over the reusable coffee filter inside the coffee filter holder. The brewer's penetrator or needle enters the holder via an opening in the holder cap and injects pressurized heated water into the holder to combine with the coffee. The outflow of the coffee beverage exits the holder via an opening in its bottom and dispenses into a separate and existing cup or container.

After each use, and before the next brew cycle can be started, the coffee grounds must be removed from the reusable filter. This process can be time consuming because the reusable filter is hot and difficult to handle. If allowed to cool, however, the used coffee grounds can become hard and compacted, requiring the filter to be tapped against a hard surface to release the grounds. This can result in damage to the filter. Additionally, used coffee grounds can be easily spilled onto countertops and floor surfaces and potentially clog drains if rinsed or discarded into sinks.

To this end, a need exists for a disposable beverage filter that overcomes the problems and limitations of prior art filters. It is to such a filter that the present invention is directed.

### SUMMARY OF THE INVENTION

In one aspect of the present invention, a disposable beverage filter comprises a self-supporting basket portion formed from a water permeable material with one or more chambers having a ring-shaped opening thereto; and a collar disposed about an outer periphery of the ring-shaped opening of the basket portion, the collar fitting over an exterior opening of a reusable coffee filter holder of a reusable coffee filter and is configured to fit precisely within, and designed to be coterminous with an existing, reusable coffee filter holder.

In another aspect of the present invention, a disposable beverage filter comprises a basket portion formed from a water permeable material having a ring-shaped opening thereto; a collar attached to and disposed about an outer periphery of the ring-shaped opening of the basket portion, the collar fitting over an exterior opening of a coffee filter holder of a reusable coffee filter, and is configured to fit precisely within, and designed to be coterminous with, a prior art, separate and existing, reusable coffee filter holder. A tab can extend from the disposable beverage filter, wherein the tab extends from an inner edge of the collar and extends into the ring-shaped opening.

These and other features, aspects and advantages of the present invention will become better understood with reference to the following drawings, description and claims.

### BRIEF DESCRIPTION OF THE DRAWINGS

FIG. 1 is an exploded perspective view of a beverage filter assembly according to an exemplary embodiment of the present invention;

FIG. 2 is a perspective view of a disposable beverage filter used in the beverage filter assembly of FIG. 1;

FIG. 3 is a side view of the disposable beverage filter of FIG. 2;

FIG. 4 is a top view of the disposable beverage filter of FIG. 2;

FIG. 5 is a perspective view of a disposable beverage filter having a tab according to an exemplary embodiment of the present invention;

FIG. 6 is a perspective view of the disposable beverage filter showing an exemplary demarcation line showing how different materials may be used to create the basket portion of the disposable beverage filter;

FIG. 7 is a side view of a disposable beverage filter showing two distinct chambers according to an exemplary embodiment of the present invention; and

FIG. 8 is a side view of a three chamber disposable beverage filter having a separate product disposed within each chamber with a sealing member according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a disposable filter that does not include any impermeable materials for structure or support, such as an outer container with a bottom and/or a sidewall, that can replace a reusable filter in, for example, a Keurig® My K-Cup® reusable coffee filter or the like. The disposable filter can be removed immediately after use and discarded without mess, making the single cup brewer available without delay for the next brew cycle. The disposable filter includes a self-supporting basket portion having a collar, where the basket portion can fit precisely into a reusable coffee filter holder and the collar can rest over a lip of the reusable coffee filter holder.

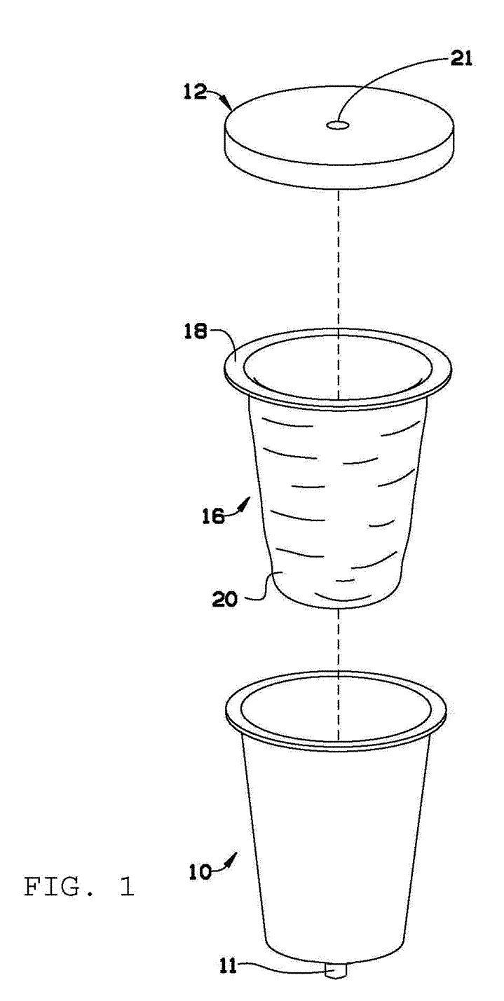

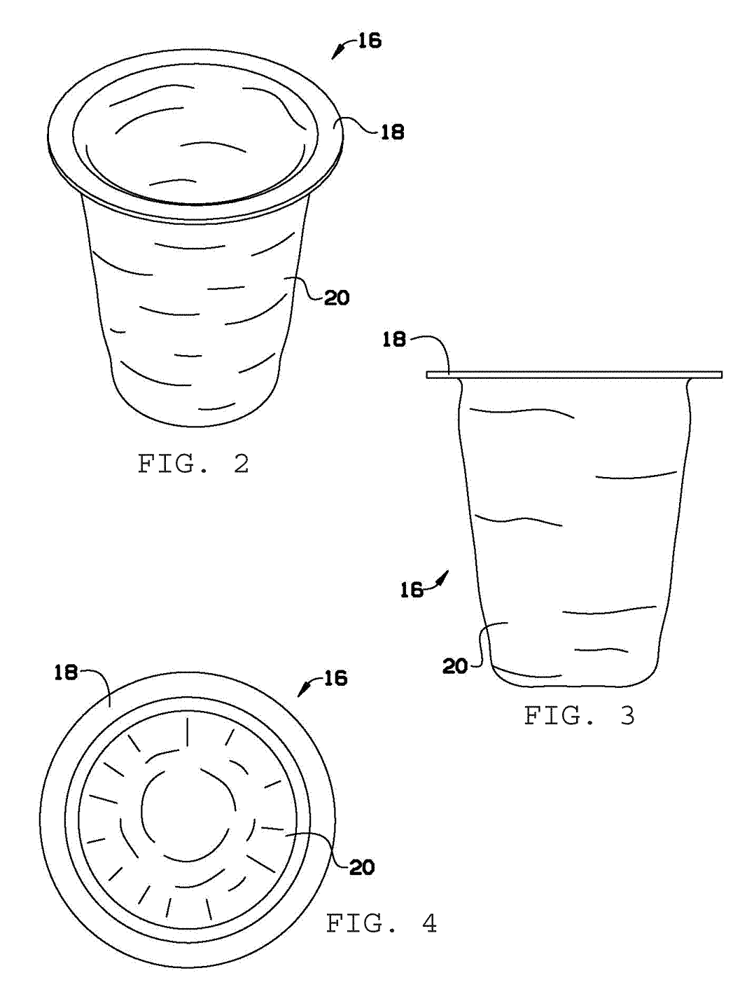

Referring to FIGS. 1 through 3, a disposable beverage filter 16 includes a self-supporting basket portion 20 and a collar 18. Similar to the conventional reusable beverage filters, the disposable beverage filter 16 can be designed to be placed into a reusable coffee filter holder 10. The reusable coffee filter holder cap 12 can fit over the reusable coffee filter holder 10 to prevent, by sealing with the collar 18, leakage of injected pressurized heated water or coffee grounds from the disposable beverage filter 16.

The basket portion 20 can be separately attached to the collar 18 or may be manufactured as a single unit. The basket portion 20 can be made of a water permeable material that will allow for the filtration of product medium, such as a paper-based material or a compostable corn-based material, a natural mesh material, or the like. As described below, in some embodiments, the basket portion 20 can be made from two or more different materials attached together to form the basket portion 20.

The basket portion 20 can have side walls that are designed with flutes or pleats, forming channels along the side of the basket portion 20. The length of the basket portion 20 can vary. In some embodiments, a bottom portion of the basket portion 20 may rest on the bottom of the filter holder. In other embodiments, the bottom portion of the basket portion may be shortened, providing head space between the filter bottom and the filter holder bottom. The basket portion 20 can be formed in various shapes, including conical, frustoconical, tubular, or the like. The bottom of the basket portion 20 can be designed in various shapes as well, including curved, circular, flat, and the like.

The filter 16 can be made permeable to liquids and can be formed from various commercially available materials, including paper-based material or a compostable corn-based material, a natural mesh material, or the like. In some embodiments, the entire filter 16 is made from biodegradable, compostable permeable materials.

The collar 18 can be formed of a resilient material so as to provide a gasket and seal between the reusable coffee filter holder 10 and the reusable coffee filter holder cap 12. The collar 18 can be made from, for example, multiple layers of the material forming the basket portion 20. The collar 18 can be made from other materials, provided that the basket portion 20 can attach thereto.

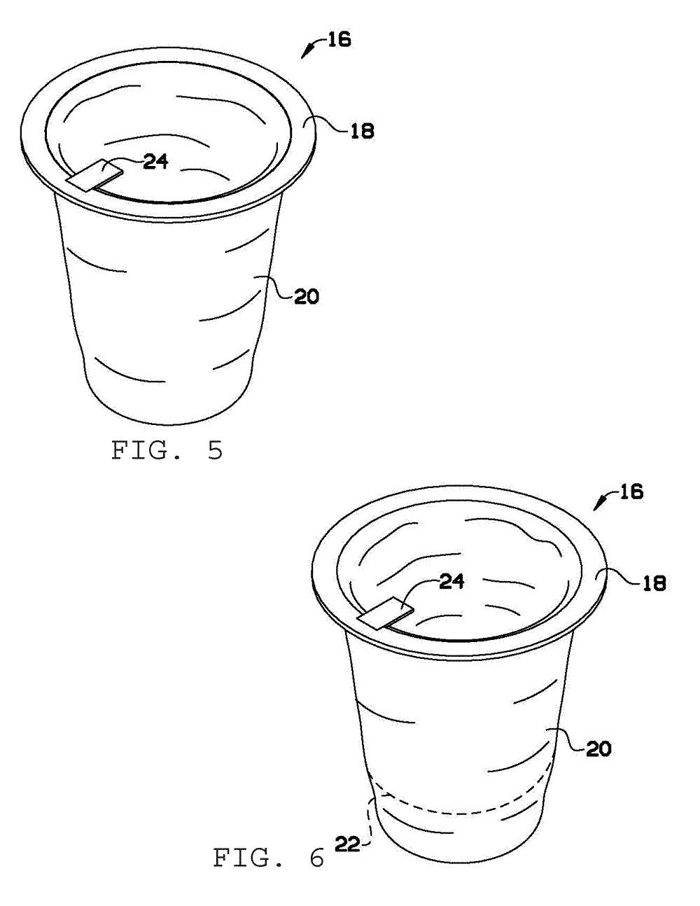

Referring now to FIG. 5, a tab 24 can be included on the disposable beverage filter 16. The tab 24 may extend from the disposable beverage filter 16 to permit a user to easily grasp the disposable beverage filter 16 and remove it from the reusable coffee filter holder 10. In some embodiments, the tab 24 can extend from the collar 18 toward an inside of the ring-shape of the collar 18. The tab 24 can be made from various materials and may be the same or different material as that of the collar 18.

Referring to FIG. 6, the basket portion 20 may be formed from more than one material. A material line of demarcation 22 can indicate where two different materials connect together. The different materials may be designed for different applications. For example, for use with tea, a user may desire a less permeable material at a lower end of the basket portion 20 to provide the tea with steeping time. The different materials can be two different materials, different thicknesses of the same material, overlap of materials, or the like. Although the material line of demarcation 22 is shown at a particular location along the basket portion 20, the specific location of the material line of demarcation 22 can be located in various positions on the basket portion 20. Moreover, multiple materials and multiple material lines of demarcation 22 may be used in the basket portion 20.

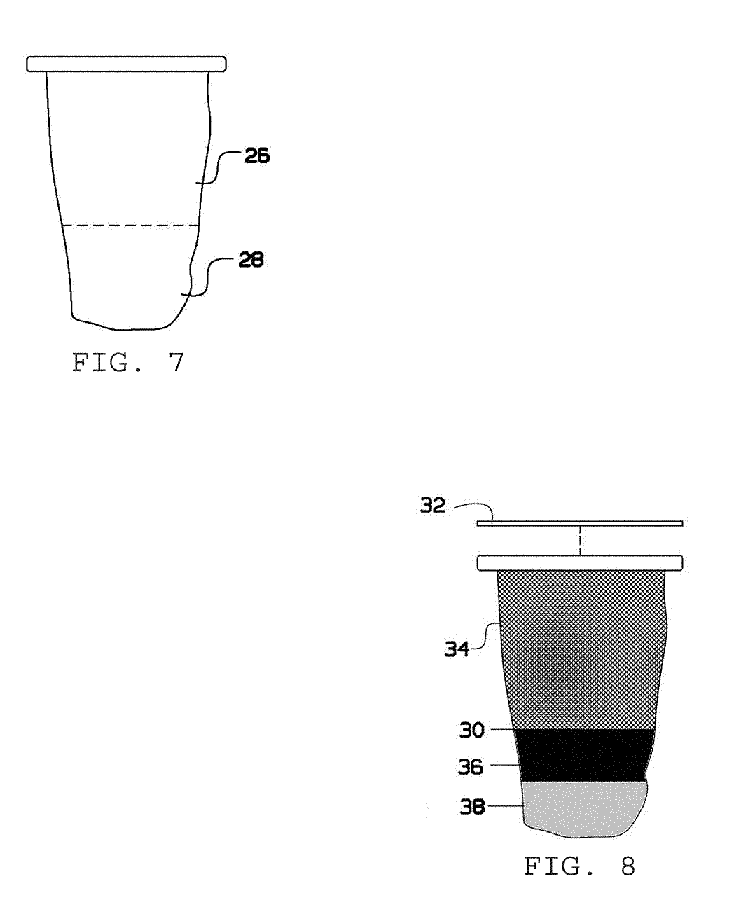

Referring now to FIG. 7, the basket portion 20 can include one or more chambers, such as two chambers, for example, as shown in FIG. 7. An upper chamber 26 and a lower chamber 28. The two chambers 26, 28 can be used for various purposes. In some embodiments, each chamber may include a different material, such as coffee grounds in one chamber and a flavoring or non-dairy creamer in another chamber. The material for each chamber 26, 28 may be the same or different. Although the upper chamber 26 and the lower chamber 28 are shown at a particular configuration to form the basket portion 20, the relative size (proportion relative to the size of the entire basket portion 20) of each of the upper and lower chambers 26, 28 can vary. Moreover, additional chambers can be contemplated within the scope of the present invention.

Referring to FIG. 8, the basket portion can include one or more chambers, such as three chambers, for example, as shown in FIG. 8. An upper chamber 34, a middle chamber 36, and a lower chamber 38 can be separated by a base material 30. The base material 30 may be, for example, a paper-based material or a compostable corn-based material, a natural mesh material, or the like. All of the chambers 34, 36, 38 can be filled with product. For example, as shown in FIG. 8, the upper chamber 34 may include product, such as coffee grounds, the middle chamber 36 may include product, such as sugar, and the lower chamber 38 may include product, such as non-dairy creamer. In this configuration, the pre-packaged product can be agitated in the upper chamber, possibly flow controlled, and the extracted liquid can flow to the lower chambers, mix with each product and then flow out of the reusable coffee filter holder 10.

A pierceable cover 32 can be provided to cover the ring-shaped opening formed by the collar 18 to seal product inside. The cover 32 can be made from various materials, including one or more of paper, corn-based products, foil, plastic or the like. The cover 32 can be removable or permanent.

The filter 16 can be formed in other configurations. For example, in a multiple chamber embodiment, instead of stacked chambers, as shown in FIG. 8, the chambers may be nested within one another. For example, a creamer and/or sugar chamber may be nested within a coffee chamber. In other embodiments, the chambers may be disposed as vertical chambers, as opposed to the horizontal chambers illustrated by example in FIG. 8.

The disposable beverage filter 16 can be packaged in various forms. For example, the disposable beverage filter 16 can be stacked together or may be pressed flat for a user to push open the filter basket portion 20. In some embodiments, the disposable beverage filter 16 may be compressed and inserted into a packet similar to that of a typical tea bag, for example.

It should be understood, of course, that the foregoing relates to exemplary embodiments of the invention and that modifications may be made without departing from the spirit and scope of the invention as set forth in the following claims.

What is claimed is:

1. A disposable beverage filter comprising:
a basket portion formed from a water permeable material having a ring-shaped opening thereto, wherein the basket portion excludes any impermeable materials for structure or support, and further excludes an outer container or assembly with a bottom or a sidewall; and
a collar attached directly to and disposed about an outer periphery of the ring-shaped opening of the basket portion;
a separate reusable coffee filter holder; and
a removable and replaceable filter holder cap disposed over the coffee filter holder, wherein
the collar is in direct contact with an undersurface of the filter holder cap; and
the basket portion is disposed directly adjacent the reusable coffee filter holder without any intermediate structure therebetween.

2. The disposable beverage filter of claim 1, wherein the basket portion fits precisely within, and is designed to be coterminous with, the reusable coffee filter holder.

3. The disposable beverage filter of claim 1, wherein the collar and the basket portion are formed as an integral unit.

4. The disposable beverage filter of claim 1, wherein the collar and the basket portion are formed separately and joined together.

5. The disposable beverage filter of claim 1, further comprising a tab extending from the disposable beverage filter.

6. The disposable beverage filter of claim 5, wherein the tab extends from an inner edge of the collar and extends into the ring-shaped opening.

7. The disposable beverage filter of claim 1, wherein the basket portion includes at least two different materials forming different portions of the basket portion.

8. The disposable beverage filter of claim 1, wherein the basket portion includes at least a first chamber and a second chamber.

9. The disposable beverage filter of claim 8, wherein at least one of the first chamber and the second chamber includes a pre-packaged product.

10. The disposable beverage filter of claim 1, wherein the basket portion includes three or more chambers.

11. The disposable beverage filter of claim 1, further comprising a cover disposed over the ring-shaped opening, the cover sealing product inside and being pierceable to admit a heated liquid.

12. A disposable beverage filter comprising:
a basket portion formed from a water permeable material having a ring-shaped opening thereto wherein the basket portion excludes any impermeable materials for structure or support, and further excludes an outer container or assembly with a bottom or a sidewall;
a collar attached directly to and disposed about an outer periphery of the ring-shaped opening of the basket portion;
a separate reusable coffee filter holder;
a removable and replaceable filter holder cap disposed over the coffee filter holder, wherein the collar is in direct contact with an undersurface of the filter holder cap; and
a tab extending from the disposable beverage filter, wherein
the tab extends from an inner edge of the collar and extends into the ring-shaped opening; and.
the basket portion is disposed directly adjacent the reusable coffee filter holder without any intermediate structure therebetween.

13. The disposable beverage filter of claim 12, wherein the basket portion includes at least two different materials forming different portions of the basket portion.

14. The disposable beverage filter of claim 12, wherein the basket portion includes at least a first chamber separated from a second chamber.

15. A disposable beverage filter comprising:
a basket portion formed from a water permeable material having a ring-shaped opening thereto, the basket portion divided into two or more chambers wherein the basket portion excludes any impermeable materials for structure or support, and further excludes an outer container or assembly with a bottom or a sidewall;
a collar disposed about an outer periphery of the ring-shaped opening of the basket portion;
a separate reusable coffee filter holder; and
a removable and replaceable filter holder cap disposed over the coffee filter holder, wherein the collar is in direct contact with an undersurface of the filter holder cap; and
a beverage brewing product is disposed in at least one of the two or more chambers, wherein
the basket portion is disposed directly adjacent the reusable coffee filter holder without any intermediate structure therebetween.

16. The disposable beverage filter of claim 15, wherein the collar and the basket portion are formed as an integral unit.

17. The disposable beverage filter of claim 15, wherein the collar and the basket portion are formed separately and joined together.

18. The disposable beverage filter of claim 15, further comprising a tab extending from the disposable beverage filter.

19. The disposable beverage filter of claim 18, wherein the tab extends from an inner edge of the collar and extends into the ring-shaped opening.
